(19) United States
(12) Patent Application Publication
(10) Pub. No.: US 2010/0246741 A1
(43) Pub. Date: Sep. 30, 2010

(54) NUCLEAR-PLANT SAFETY SYSTEM OPERATING DEVICE

(75) Inventor: Yasuyuki NISHIJIMA, Tokyo (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Chiyoda-ku (JP)

(21) Appl. No.: 12/533,080

(22) Filed: Jul. 31, 2009

(30) Foreign Application Priority Data
Mar. 25, 2009 (JP) 2009-074395

(51) Int. Cl. G21C 17/00

(52) U.S. Cl. 376/259

(57) ABSTRACT

There are provided a first display that displays a system diagram of a safety system and makes it possible to select a symbol indicating a safety-system plant equipment included in the system diagram; a second display that displays an operating device for operating the safety-system plant equipment and makes it possible to operate the operating device; and a safety system display control device that outputs the system diagram to be displayed on the first display, outputs on the second display an operating device corresponding to a symbol that is included in the system diagram and is selected by means of the first display, and converts operation of the operating device performed on the second display into a signal that is outputted to the safety-system plant equipment.

### BACKGROUND OF THE INVENTION

1. Field of the Invention

The present invention relates to a nuclear-plant safety system operating device for operating safety system plant equipments included in a nuclear-plant safety system.

2. Description of the Related Art

A plant-operation monitoring control system in a nuclear plant can be divided into a non safety-system related to ordinary operation of the plant and a safety system, related to the safety of the plant, for performing plant-protection in which, for example, the plant is out of order, the plant is stopped (trips) and for performing monitoring control over confinement of radioactive materials. In order to prevent a failure in the safety system from disabling the functions of the safety system, the non safety-system and the safety system are separated from each other. With regard to a human-machine interface (HMI) with which a plant operator or the like performs operation monitoring control, a human-machine interface for the non safety-system and human-machine interface for the safety system are also separated from each other. That is to say, displays to be mounted in an operation console for an operator's manipulation or in a command console for a supervisor's monitoring include non safety-system displays, which are HMIs for a non safety-system, and safety-system displays, which are HMIs for a safety system.

In a non safety-system display, there is provided a screen system that enables monitoring of the whole-plant situation and operating of plant equipments related to ordinary operation. In contrast, in a safety-system display, there is provided a screen system that enables operation related to the protection and safety of a plant.

In a conventional nuclear-plant safety system operating device, items indicating the safety status of a plant are always displayed at a fixed position in the screen of a large-size display device; the operation status of the whole plant is displayed on a CRT display device in a operation console; a system diagram related to systems that configure a nuclear plant and information that enables operating of individual devices and apparatuses are displayed on an operation means (e.g., refer to Japanese Patent Application Laid-Open No. 2005-114516 (paragraph 0016 to paragraph 0018)).

In a conventional nuclear-plant safety system operating device, a system diagram related to systems that configure a nuclear plant and information that enables operating of individual safety-system plant devices and apparatuses are displayed on an operation means. Accordingly, operating devices may be displayed in such a way as to be superimposed on the system diagram. In consequence, there has been a problem that the operating devices hide the system diagram that has been displayed. Japanese Patent Application Laid-Open No. 2005-114516 allegedly claims that the foregoing problem can be solved by displaying items indicating the safety status of a plant at a fixed position in the screen of a large-size display device; however, because, in a series of operations in which a device is selected from the displayed system diagram and operated, it is required to refer to the large-size display device that is disposed at a position different from the position of an operation console that is manipulated by an operator, there has been a problem that the manipulation becomes complicated.

### SUMMARY OF THE INVENTION

The present invention has been implemented in order to solve the foregoing problems; it is the objective thereof that, when a discrete safety-system plant equipment is selected from a system diagram displayed on a safety-system display, the corresponding operating device is displayed at a place different from the place where the system diagram is displayed so that the system diagram is displayed as it is.

A nuclear-plant safety system operating device according to the present invention is provided with a first display that displays a system diagram of a safety system and makes it possible to select a symbol indicating a safety-system plant equipment included in the displayed system diagram; a second display that displays an operating device for operating a safety-system plant equipment and makes it possible to operate the displayed operating devices; and a safety system display control device that outputs the system diagram to be displayed on the first display, outputs on the second display the operating device for the safety-system plant equipment corresponding to a symbol which is included in the system diagram and is selected by means of the first display, and converts the operation performed on the second display into a signal that is outputted to the safety-system plant equipment.

In the present invention, a display that displays a system diagram and a display that displays operating devices are separated from each other; thus, when a discrete safety-system plant equipment is selected from a system diagram displayed on a safety-system display, the corresponding operating device is displayed at a place different from the place where the system diagram is displayed, so that the system diagram can be displayed as it is.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram illustrating a nuclear-plant safety system operating device according to Embodiment 1 of the present invention;

FIG. 2 is a detailed block diagram illustrating a nuclear-plant safety system operating device according to Embodiment 1 of the present invention;

FIG. 3 is a set of views illustrating examples of display screens in a nuclear-plant safety system operating device according to Embodiment 1 of the present invention; and

FIG. 4 is a set of views illustrating examples of display screens in a nuclear-plant safety system operating device according to Embodiment 2 of the present invention.

### DETAILED DESCRIPTION OF THE INVENTION

### Embodiment 1

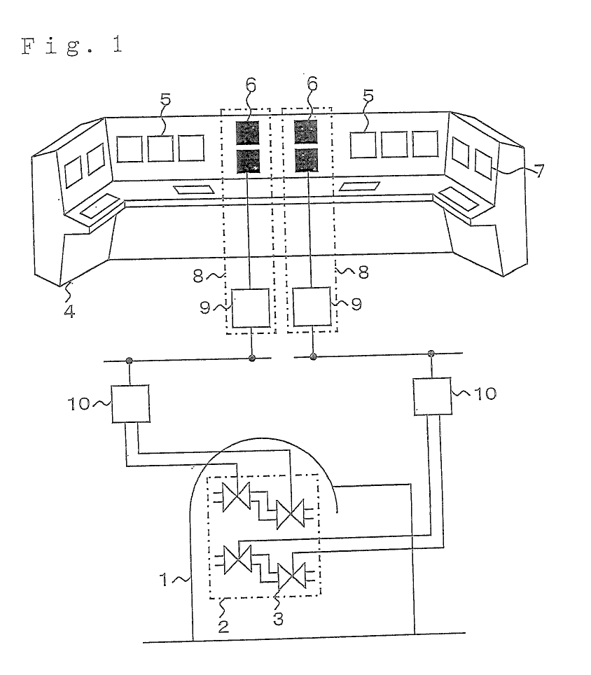

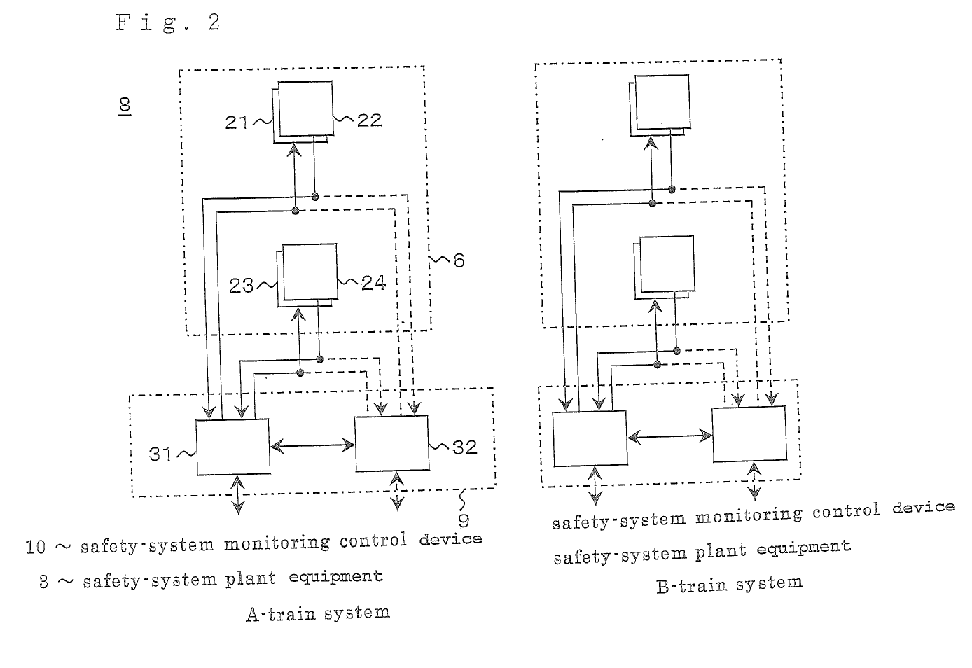

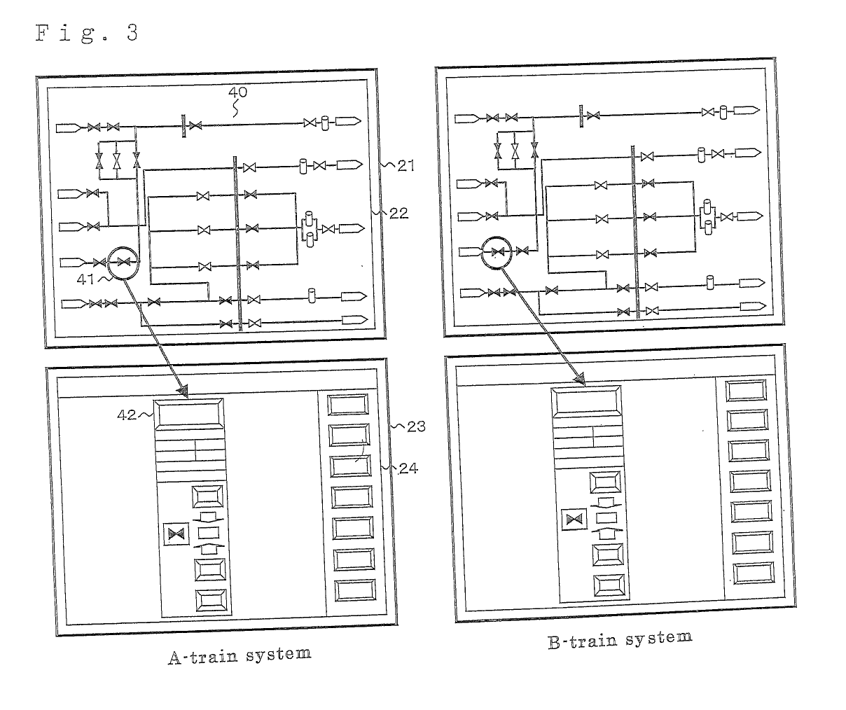

FIG. 1 is a schematic block diagram illustrating a nuclear-plant safety system operating device according to Embodiment 1 of the present invention; FIG. 2 is a detailed block diagram; and FIG. 3 is a set of views illustrating examples of display screens.

In FIG. 1, an operation console 4 for operating a nuclear plant 1 is configured with a non safety-system display 5 for performing ordinary operation and monitoring, a safety-system display 6 for monitoring and controlling safety-system plant equipment 3 (including also safety-system plant equipment) included in a safety system 2 that protects the nuclear plant 1 and ensures the safety thereof when the nuclear plant 1 is out of order, an alarm display 7 for displaying an alarm, and the like. In FIG. 1, as a screen of the safety-system display 6, four screens are illustrated; the two screens at the left-hand side are a pair of safety-system displays that forms an A-train safety-system display, and the two screens at the right-hand side are a pair of safety-system displays that forms a B-train safety-system display. Depending on the safety-system configuration of a nuclear plant, the safety-system display may consist of four trains; in this case, it is made possible that four groups of safety-system displays are provided in an operation console, or that two or three groups of safety-system displays are provided and the groups are switched by means of a switch.

A safety system display control device 9, connected to the nuclear plant 1, for controlling the safety-system display 6 transmits to the safety-system plant equipment 3 information to be displayed on the safety-system display 6 and information that is handled through the safety-system display 6, via a safety-system monitoring control device 10. In a safety-system control device of the nuclear plant 1 includes a great number of devices such as a protection device for stopping the plant when the plant is out of order and a safety facility operating device for preventing radioactive materials from leaking out, and these devices are connected with one another through a network corresponding to a utilized logic; however, in FIG. 1, these devices are typified by the safety-system monitoring control device 10. In FIG. 1, the constituent elements, of the nuclear-plant safety system operating device 8, included in the present invention are the safety-system display 6 and the safety system display control device 9. In FIG. 1, the safety system display control device 9 is situated in a place different from the place where the operation console 4 is situated; however, the safety system display control device 9 can be disposed also inside the operation console 4.

FIG. 2 represents the details of the nuclear-plant safety system operating device 8; the left-half and right-half parts of FIG. 2 represent the A-train system and the B-train system, respectively. Because the A-train system and the B-train system are configured in the same manner, only the A-train system will be explained and the explanation for the B-train system will be omitted. The safety-system display 6 is provided with a first display 21 that displays a system diagram, a first touch panel 22 that belongs to the first display 21 and is provided on top of the surface of the first display 21, a second display 23 that displays an operating device for operating the safety-system plant equipment 3, and a second touch panel 24 that belongs to the second display 23 and is provided on top of the surface of the second display 23. The safety system display control device 9 is provided doubly so that it does not stop due to a single failure; thus, the safety system display control device 9 is provided with a first display control device 31 that is in an operation mode and a second display control device 32 that is in a standby mode. The first display control device 31 constantly collects information on the state of the nuclear plant 1 from the safety-system monitoring control device 10, and makes the first display 21 display the latest state of the nuclear plant 1. The second display control device 32 in the standby mode also constantly collects information on the state of the nuclear plant 1 from the safety-system monitoring control device 10; when the first display control device 31 stops due to a failure or the like, the second display control device 32 comes into the operation mode and instantaneously replaces the first display control device 31.

The first display control device 31 and the second display control device 32 are each connected with both the first touch panel 22 and the second touch panel 24 and are each capable of receiving operation information displayed on both the first touch panel 22 and the second touch panel 24.

FIG. 3 is a set of views illustrating only the safety-system display 6 out of the display screens of the nuclear-plant safety system operating device 8; as is the case with FIG. 2, the left-half and right-half parts of FIG. 3 represent the A-train system and the B-train system, respectively. Because the A-train system and the B-train system are configured in the same manner, only the A-train system will be explained and the explanation for the B-train system will be omitted. Out of two screens in the A-train system, the upper one is the first display 21, and the lower one is the second display 23; the first display 21 and the second display 23 have the first touch panel 22 and the second touch panel 24, respectively. On the first display 21, a system diagram 40 including valves and the like is displayed; on the second display 23, there is displayed an operating device 42 that is to be manipulated and corresponds to a symbol 41 among symbols, for the safety-system plant equipments 3, that are displayed on the first display 21. The A-train system and the B-train system are different from each other in terms of the safety-system plant equipment 3 that can be operated; by means of the second display 23 in the A-train system, the safety-system plant equipment 3 in the A-train system can be operated, and by means of the second display in the B-train system, the safety-system plant equipment in the B-train system can be operated. The operating device for operating the safety-system plant equipment 3 is displayed definitely on the second display 23, not on the first display 21; in contrast, information, such as a system diagram, which is not directly related to operation of the safety-system plant equipment 3 is not displayed on the second display 23.

Next, the operation will be explained. In performing monitoring operation of the plant, in the case where it is required to operate the safety-system plant equipment 3, firstly, the system in which the safety-system plant equipment 3 is included is selected. The safety system of a nuclear plant is configured with a plurality of systems such as a safety injection system, a residual heat removal system, and a nuclear reactor containment spray system, and the safety-system plant equipment 3 is included in one of these systems. In order to display a subject system on the first display 21, firstly, a selection display such as a system list display is displayed; then, the subject system is selected, and the system diagram 40 is displayed. In the case where an alarm or the like is issued, there may be displayed a target system that is linked to the alarm. The safety system display control device 9 has the display specification of the system diagram 40, and displays the latest information, on the states of apparatuses in the system diagram 40, that is collected from the safety-system monitoring control device 10 that constantly collects data on the states.

When the symbol 41 (in FIG. 3, a valve is indicated) corresponding to the safety-system plant equipment 3 to be operated is selected, a signal related to the selection is transmitted from the first touch panel 22 to the first display control device 31; the display of the operating device corresponding to the selected safety-system plant equipment 3 is extracted from data that is stored in the first display control device 31, and the display of the operating device and the latest state of the safety-system plant equipment 3 are displayed, as the operating device 42, on the second display 23. In the case where the safety-system plant equipment 3 selected through the first display 21 is a motor, the operating device corresponding to the motor is displayed; in the case where the selected safety-system plant equipment 3 is a valve for controlling an opening level, there is displayed the operating device, for the valve, through which the opening level can be controlled. When, on the second display 21, the safety-system plant equipment 3 (in the case of a valve for controlling opening and closing) is operated through the displayed operating device 42 so as to change its state, for example, from being opened to being closed, with reference to the system diagram 40 displayed on the first display 21, a signal related to the operation is transmitted from the second touch panel 24 to the first display control device 31, signal-converted, and then sent to the safety-system plant equipment (valve) 3 via the safety-system monitoring control device 10, so that the valve changes its state from being opened to being closed.

As described above, a display that displays a system diagram and a display that displays an operating device are separated from each other so that the system diagram is displayed on the first display and the operating device is displayed on the second display; therefore, when a discrete safety-system plant equipment is selected from a system diagram displayed on a safety-system display, the corresponding operating device is displayed at a place different from the place where the system diagram is displayed, so that the system diagram can be displayed as it is. Operating devices for directly operating safety-system plant equipments and information, such as a system diagram, which is not directly operated are separately displayed in a clear manner on the second display and the first display, respectively; therefore, it is made possible to make an operator recognize that he is carrying out the operation of a safety-system plant equipment, i.e., an important work, by performing manipulation on the second display.

The first display that displays a system diagram is disposed upper than the second display that displays an operating device; thus, an operator can manipulate an operating device displayed on the second display while looking at the system diagram, without shutting out the system diagram displayed on the first display by the operator's hand or the like.

Because a touch panel is applied to operation on the display, an operator can perform work, by looking at two displays, i.e., the first display on which a system diagram is displayed and the second display on which an operating device is displayed; therefore, the operator's manipulation is not complicated.

### Embodiment 2

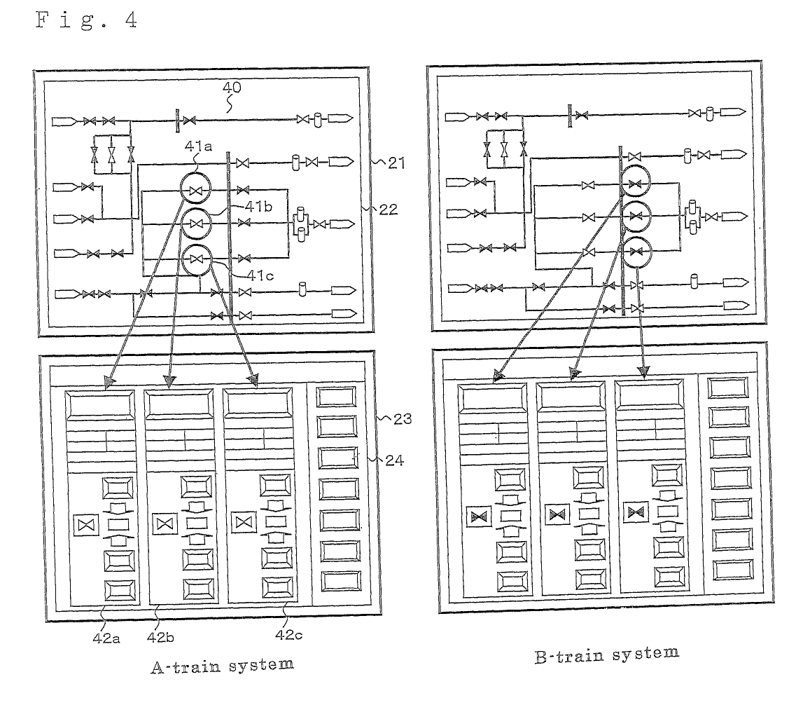

In Embodiment 1, on the second display 23, there is displayed a single operating device 42 corresponding to the symbol 41 for the safety-system plant equipments 3 that is displayed on the first display 21; however, in Embodiment 2, as illustrated in FIG. 4, on the second display 23, there may be displayed a plurality of operating devices 42a, 42b, and 42c corresponding to a plurality of symbols 41a, 41b, and 41c, for the safety-system plant equipments 3, that are displayed on the first display 21. The configuration of a nuclear-plant safety system operating device in Embodiment 2 is the same as that illustrated in FIG. 1 or FIG. 2 in Embodiment 1. The same reference marks in the figures indicate the same or equivalent constituent elements.

The operation in Embodiment 2 will be explained below. As is the case with the method described in Embodiment 1, after a subject system diagram 40 is displayed on the first display 21, the symbol 41a corresponding to the safety-system plant equipment 3 to be operated is selected; a signal related to the selection is transmitted from the first touch panel 22 to the first display control device 31; the display of the operating device corresponding to the selected safety-system plant equipment 3 is extracted from data that is stored in the first display control device 31; and the display of the operating device and the latest state of the safety-system plant equipment 3 are displayed, as the operating device 42a, on the second display 23. After that, when being selected, the symbol 41b corresponding to another safety-system plant equipment 3 is displayed, as the operating device 42b, on the second display 23; when being selected, the symbol 41c corresponding to further another safety-system plant equipment 3 is displayed, as the operating device 42c, on the second display 23. In such a way as described above, the operating devices 42a, 42b, and 42c are concurrently displayed on the second display 23.

As far as a safety-system plant equipment is concerned, it is often configured as a multiplex apparatus; for example, many safety-system plant equipments include totally three systems such as a first valve system, a second valve system, and a backup valve system. In order to operate a nuclear plant, it is required to concurrently or continuously operate the plurality of safety-system plant equipments. By displaying three operating devices on the second display, the concurrent or the continuous operation can be performed.

In the foregoing operation, by sequentially selecting the three symbols displayed on the first display 21, the three operating devices 42a, 42b, and 42c are sequentially displayed on the second display 23; however, in the case of a plant equipment that is a multiplex apparatus and requires continuous or concurrent operation, it may be possible that, by selecting a single symbol (e.g., 41b), the three operating devices 42a, 42b, and 42c are concurrently displayed on the second display 23.

While the presently preferred embodiments of the present invention have been shown and described. It is to be understood that these disclosures are for the purpose of illustration and that various changes and modifications may be made without departing from the scope of the invention as set forth in the appended claims.

What is claimed is:

1. A nuclear-plant safety system operating device for operating a safety-system plant equipment included in a safety system of a nuclear plant, the nuclear-plant safety system operating device comprising:
a first display that displays a system diagram of the safety system and makes it possible to select a symbol indicating the safety-system plant equipment included in the system diagram displayed;
a second display that displays an operating device for operating the safety-system plant equipment and makes it possible to operate the operating device displayed; and
a safety system display control device that outputs the system diagram to be displayed on the first display, outputs on the second display the operating device for operating the safety-system plant equipment corresponding to a symbol that is included in the system diagram and is selected by means of the first display, and converts operation of the operating device performed on the second display into a signal that is outputted to the safety-system plant equipment.

2. The nuclear-plant safety system operating device according to claim 1, wherein a plurality of operating devices corresponding to a plurality of safety-system plant equipments is displayed on the second display.

3. The nuclear-plant safety system operating device according to claim 1, wherein the first display is provided with a first touch panel for converting selection of the symbol into a signal, and the second display is provided with a second touch panel for converting operation of the operating device into a signal.

4. The nuclear-plant safety system operating device according to claim 2, wherein the first display is provided with a first touch panel for converting selection of the symbol into a signal, and the second display is provided with a second touch panel for converting operation of the operating device into a signal.

5. The nuclear-plant safety system operating device according to claim 1, wherein the first display is disposed upper than the second display.

6. The nuclear-plant safety system operating device according to claim 2, wherein the first display is disposed upper than the second display.
